(19) United States
(12) Patent Application Publication
(10) Pub. No.: US 2010/0103687 A1
(43) Pub. Date: Apr. 29, 2010

(54) TRACK LIGHTING ASSEMBLY EMPLOYING INTERIM ASSEMBLY BETWEEN TRACK AND TRACK HEAD

(75) Inventor: Nelson Pitlor, Twinsburg, OH (US)

Correspondence Address: RENNER OTTO BOISSELLE & SKLAR, LLP, 1621 EUCLID AVENUE, NINETEENTH FLOOR, CLEVELAND, OH, 44115, US

(73) Assignee: ACCESSMOUNT LLC, Twinsburg, OH (US)

(21) Appl. No.: 12/524,861

(22) PCT Filed: Jan. 30, 2008
(86) PCT No.: PCT/US2008/052457

§ 371 Date: Dec. 13, 2009

Related U.S. Application Data
(60) Provisional application No. 60/887,345, filed on Jan. 30, 2007.

(51) Int. Cl. F21V 21/34

(52) U.S. Cl. 362/398; 362/382

(57) ABSTRACT

A mounting system for attaching a track lighting head to a track includes an interim assembly including a track attachment device adapted to selectively attach the interim assembly to the track, a track head, and a remotely operable head attachment device for attaching the track head to the interim assembly. An attachment design of the track attachment device is different than an attachment design of the head attachment device.

### TECHNICAL FIELD

The invention relates generally, as indicated, to track lighting assemblies, and, more particularly, to track lighting assemblies that employ an interim assembly between a track and a track head facilitating removing and installing track heads.

### BACKGROUND OF INVENTION

Track lighting is established as a convenient, adaptable, moveable lighting source. A track lighting head is typically fastened anywhere along a permanently mounted track. This head can be moved as the need arises.

Interim assemblies exist for these track heads. Typically, they house electrical transformers or use a long “stem” to create distance between the track head and the track itself. In these instances, the same track head is connected at the distal end of the interim assembly, and uses the same fastening method used between the interim assembly and the track.

This same fastening method typically uses a twist-to-lock system combined with a “catch” that prevents unintended unlocking, but provides to attachment utility itself. This system is secure, but is operable only by a user in close proximity, and by the user laying hands on the fastening system. Often it is necessary for a user to stand on a ladder, chair, step stool, etc., to reach the track lighting head to remove it from or to reattach it to the track.

It would be desirable to facilitate removing a track lighting head from a track and to reattach a track lighting head to a track without the need to stand on an object above the immediate floor.

It also would be desirable to facilitate attaching and removing of a track lighting head with respect to a track.

### SUMMARY OF THE INVENTION

A device and method in accordance with the present invention enables a remotely mounted light fixture, such as a track light fixture, to be quickly and easily serviced, without directly handling the light fixture.

According to one aspect of the invention, a mounting system for attaching a track lighting head to a track includes: an interim assembly including a track attachment device adapted to selectively attach the interim assembly to the track; a track head; and a remotely operable head attachment device for attaching the track head to the interim assembly, wherein an attachment design of the track attachment device is different than an attachment design of the head attachment device.

According to one aspect of the invention, the system further includes the track.

According to one aspect of the invention, the head attachment device is disengaged by an assembly/release tool.

According to one aspect of the invention, the head attachment device is configured such that the track head can be releasably coupled to the interim assembly without a user touching the track, the interim assembly, or the track head with hands.

According to one aspect of the invention, the track attachment device includes an interchangeable attachment assembly that allows the interim assembly to be connected to different track designs.

According to one aspect of the invention, the interim assembly contains an electrical transformer.

According to one aspect of the invention, the head attachment device comprises at least one magnet and at least one corresponding ferrous plate.

According to one aspect of the invention, the head attachment device comprises a first holding device and a second holding device different from the first holding device, each of the first and second holding devices adapted to independently hold the track head to the interim assembly.

According to one aspect of the invention, the head attachment device comprises a mechanical latch and a magnetic retainer.

According to one aspect of the invention, the mechanical latch is disengaged by insertion of a tool to separate the track head and interim assembly.

According to one aspect of the invention, the head attachment device comprises at least one clip and at least one corresponding recess, wherein the at least one clip is cooperative with the at least one recess so as to hold the track head to the interim assembly.

According to one aspect of the invention, the system further includes a light fixture, wherein at least a portion of the light fixture is attached to the track head.

According to one aspect of the invention, there is provided a remotely operable interim assembly designed to mount to a track lighting track using a pre-prescribed mounting method, and receive a separate track head assembly using a different selectively operable mounting method.

According to one aspect of the invention, the mounting method for mounting the interim assembly to the track is contained on an interchangeable assembly that could be changed to match different types of track.

Additional details regarding methods and devices for securing objects to a surface can be found in U.S. Pat. Nos. 6,644,617 and 7,287,738, and U.S. patent application Ser. No. 10/958,060 (filed on Oct. 4, 2004), the contents each being hereby incorporated by reference in their entirety.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

### BRIEF DESCRIPTION OF THE DRAWINGS

FIGS. 1-4 are respective exploded isometric views of an exemplary track-head assembly and interim assembly in accordance with the invention.

### DESCRIPTION

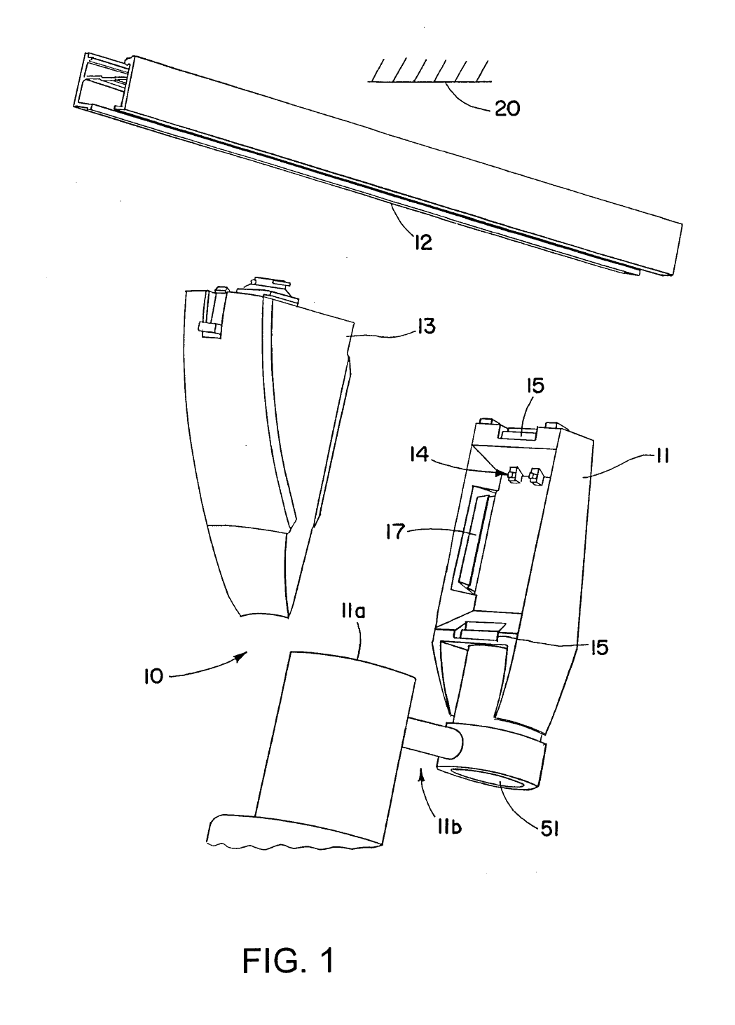

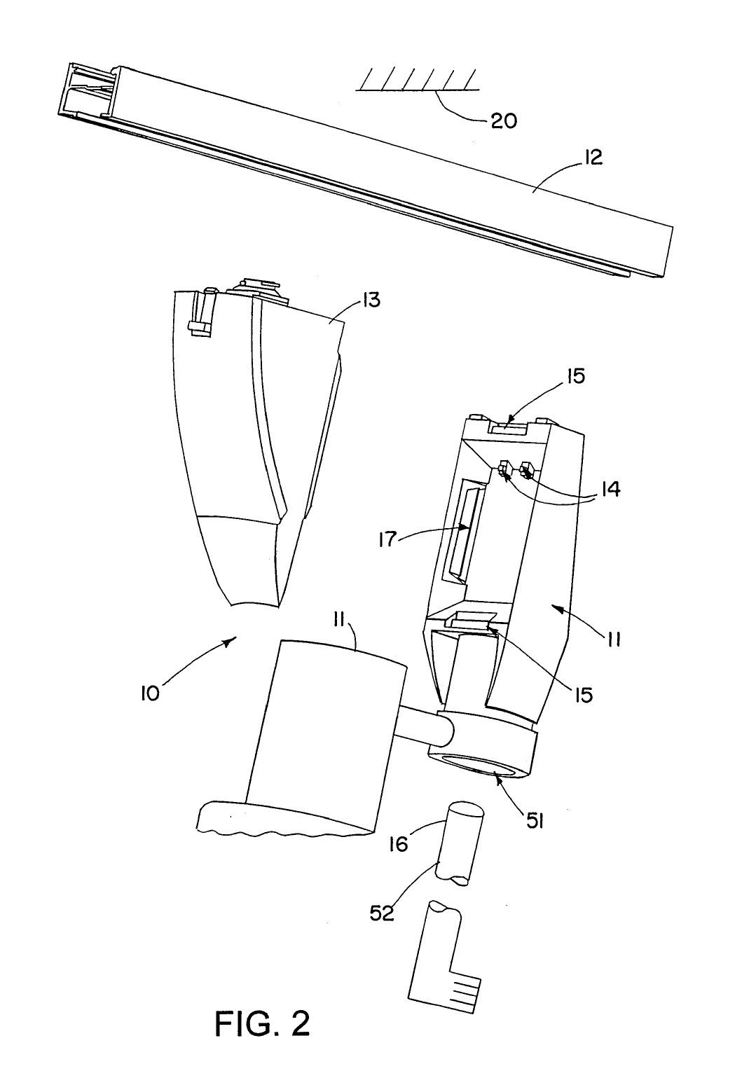

Referring to FIGS. 1 and 2, a two-stage system 10 for attaching a track lighting head 11 to a track 12 is disclosed, the system comprising: a track 12 (e.g., a standard or conventional track) that is permanently or semi-permanently attached to a surface 20 (e.g., a wall, a ceiling, etc.), an interim assembly 13 that attaches to the track 12 using an attaching mechanism configured according to the track design and method of attaching and removing with respect to the track (sometimes referred to as a pre-prescribed attaching mechanism and method); and a track head 11 that attaches to the interim assembly 13 using a different attaching method (e.g., different from the attaching method used between the track 12 and interim assembly 13) that can be operated from a distance, and by not laying hands on the track head or fastening system, itself.

Electrical current may be supplied from a power source to track conductors (not shown) in a conventional manner. The electrical current will pass between the track 12 and the interim assembly 13 using the standard method as prescribed by the track design, for example, (sometimes referred to as a pre-prescribed standard method). The electrical current will also pass from the interim assembly 13 to the track head 11, but will use electrical contacts 14, e.g., of a different contact design than the one used to pass the current between the track 12 and the interim assembly 13.

The interim assembly 13 may contain other electrical components, such as a transformer. The track head 11 may include a light bulb, fan, or other electrical component or components.

The attaching mechanism and method for holding the track head 11 to the interim assembly 13 may be a singular mechanism and method such as a magnet or magnet array 15 with an attachable rod or probe 16 to decouple from a distance, a remotely activated latch 17 (e.g., a sliding latch or other latch that can hold the head 11 to the interim assembly 13), or a combination of methods that uses plural attaching mechanisms.

An example of a plural attaching mechanism, according to a preferred embodiment of the invention, is a two-stage fastening system for attaching a track lighting head 11 to a track 12. The fastening system includes a track 12 that is permanently or semi-permanently attached to a surface 20, an interim assembly 13 that attaches to the track 12 using the pre-prescribed attaching method associated with that track, and a track head 11 that is attached to the interim assembly 13 using a different attaching method that can be operated from a distance, and by not laying or placing the user's hands on the track head or fastening system itself.

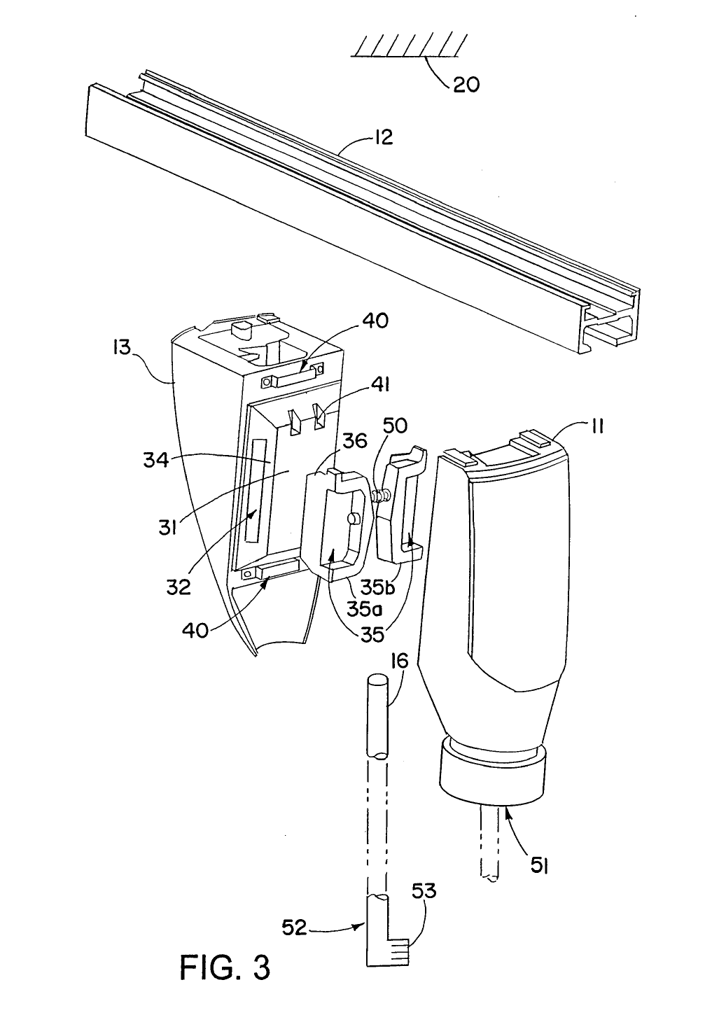

In an embodiment of the invention (shown in FIG. 3), the interim assembly 13 includes at least one outwardly extending portion (e.g., an extension that extends in a horizontal or vertical direction) 31, that extends out from the interim assembly housing 13. A slot 32 is at each side of the extension 31 formed by a rib 34. The extension 31 is paired with a corresponding outwardly extending sliding latch 35 of the track-head assembly housing 11. The sliding latch 35 has a gripping flange 36 to grip the rib 34 at slot 32 to mechanically hold the track head 11 to the interim assembly 13. The sliding latch 35 may comprise two latches 35a and 35b (collectively 35) to grip respective ribs 34 and slots 32 at opposite sides of extension 31 so as to mechanically cooperate to hold the track head 11 to the interim assembly 13. At least one ferrous plate 40 on the interim assembly housing 13 can be paired with a corresponding magnet 15 on the outer portion of the track-head assembly housing 11. Preferably there are two combinations of such magnets 15 and ferrous plates 40. At least one (preferably two) inwardly extending electrical contact cavity 41 is paired with a corresponding outwardly extending electrical contact 14 of the track head 11.

In an embodiment, the interim assembly may contain other electrical components, such as a transformer. The track head could include a light bulb, fan, or other electrical component or components.

In an embodiment, the track-head assembly includes at least one outwardly extending sliding latch 35 that extends from within the track-head assembly housing 11 such that it is paired with the corresponding extension 31 of the interim assembly housing 13. At least one magnet 15 on the outer portion of the track-head assembly housing 11 is paired with a corresponding ferrous plate 40 on the outer portion of the interim assembly housing 13. At least one outwardly extending electrical contact 14, extending from the track-head assembly housing 11, is paired with a corresponding inwardly extending electrical contact cavity 41 of the extension 31 on the interim assembly 13.

In an embodiment of the invention the sliding latches 35a and 35b of the track-head assembly 11 have gripping flanges 36 that are urged by a spring member 50 that provides a resilient force to allow the sliding latch's gripping flanges 36 to constantly engage the slot 32 and rib 34 of the extension 31 of the interim assembly housing 13.

According to an embodiment of the invention, the bottom portion of the track-head assembly 11 has a hole 51 (insertion point) that extends upwardly through a hollow portion of the track head assembly 11. The purpose of the insertion point 51 is to accept a removal (release) tool 52 that has a probe 16 on one end and a handle 53 for manual manipulation at the other end. The probe 16 can be inserted through the hole 51 to press apart or to urge apart the latches 35 to release the gripping flanges 36 from the ribs 34 at the slots 32. The probe 16 acts against the spring force on the sliding latch(es) 35a and 35b, allowing the track-head assembly 11 portion to disengage the interim assembly 13.

According to an embodiment of the invention, the track-head assembly has a removable back cover 60 that allows for accessibility to: the inner portion of track-head assembly 11; the back portion of sliding latches 35 (for removal or replacement); and the back portion of electrical contacts 14 (for removal or replacement).

In an embodiment of the invention, the track-head and interim assemblies 11 and 13 are attached when said protrusions (flanges) 36 of outwardly extending sliding latch(es) 35 of the track-head assembly 11 engage and latch to at least one of the inwardly extending slots 32 of the interim assembly, and is held in place by said constant force from the sliding latch's spring member 50. Furthermore, the track-head and interim assemblies 11 and 13 are attached such that said outwardly extending electrical contact(s) 14 of the track-head assembly 11 engage at least one of said inwardly extending electrical contact cavities 41 of the interim assembly 13 and such that said ferrous plate(s) 40 of the interim assembly 13 engage at least one of said magnets 15 of the track head assembly 11.

According to an embodiment of the invention, the track-head and interim assemblies 11 and 13 are detached when the probe 16 of the removal (release) tool 52 extends upwardly through the hole 51 in the bottom portion of the track-head assembly 11, such that the probe 16 relieves/counters the constant spring force of the sliding latch 35 allowing for the gripping flanges 36 to release/disengage the slots 32 of the extension 31. Additionally the ferrous plate(s) 40 disengage(s) the magnet(s) 15 and the outwardly extending electrical contact(s) 14 disengage(s) the inwardly extending electrical contact cavity/cavities 41.

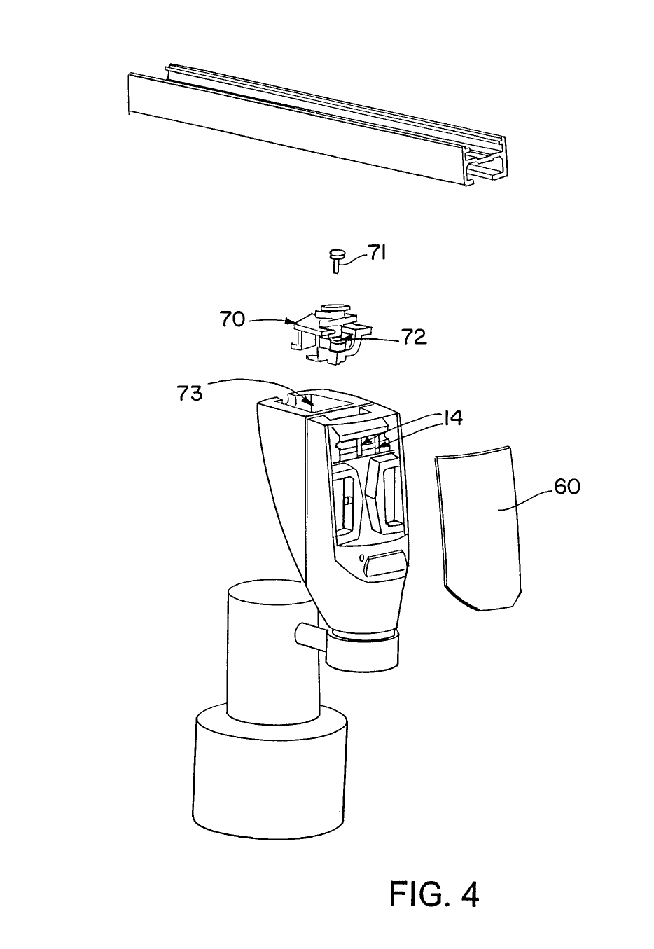

In an embodiment of the invention, the track and interim assemblies 11 and 13 are attached by an interchangeable track attachment assembly 70 that allows for interchangeability to accommodate different standard track assemblies, as shown in FIG. 4. The interchangeable track attachment assembly 70 also allows for electrical current to pass through conductors of the track 12 to interim assembly attachment (according to pre-prescribed electrical configuration of track). The interchangeable track attachment can attach to interim member by screw 71 via a screw hole 72 in the attachment assembly 70 to a screw hole 73 in interim assembly housing 13.

A light fixture or other device 11a may be attached to the track head 11, as is seen in FIG. 1.

In using the device in accordance with the invention, a light fixture or other device 11a may be attached to the track head 11, e.g., by any connection means, such as is illustrated at 11b in FIG. 1. A desired interchangeable track attachment 70 is installed in the interim assembly 13 to mate with the track 12. The interim assembly 13 is mounted on the track 12 using the attachment 70.

The probe 16 is inserted into the hole 51 to urge the latches 35a and 35b apart; at this point the track-head assembly 11 temporarily is mounted on the probe and tool 52. The tool 52 is manipulated to move the track-head assembly 11 into alignment with the interim assembly 13 allowing the magnets 15 and ferrous plates 40 to align so they grip together to hold the track-head and interim assemblies 11 and 13 together. The electrical contacts 14 and 41 of the track-head and interim assemblies 11 and 13 engage electrically with each other to complete an electrical circuit therebetween. To secure the track-head and interim assemblies 11 and 13 together mechanically, then, the probe 16 is removed to release the latches 35, which engage the ribs 34 and slots 32. The track head 11 then is securely mounted to the interim assembly 13.

To remove the track-head assembly 11 from the interim assembly 13, the tool 52 is manipulated manually, for example, to insert the probe 16 into the hole 51 to separate the latches 35a and 35b, thus releasing their grip on the interim assembly 13. The tool 52 can be slightly manipulated to release the magnetic force holding the magnets 15 and ferrous plates 40 together, thus releasing the track-head assembly 11 from the interim assembly 13. The track-head assembly 11 then can be lowered and serviced, etc., as may be desired, e.g., to replace a light bulb, etc.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A mounting system for attaching a track lighting head to a track, the system comprising:
an interim assembly including a track attachment device adapted to selectively attach the interim assembly to the track;
a track head; and
a remotely operable head attachment device for attaching the track head to the interim assembly, wherein an attachment design of the track attachment device is different than an attachment design of the head attachment device.

2. The mounting system of claim 1, further comprising the track.

3. The mounting system of claim 2, wherein the head attachment device is disengaged by an assembly/release tool.

4. The mounting system of claim 1, wherein the head attachment device is configured such that the track head can be releasably coupled to the interim assembly without a user touching the track, the interim assembly, or the track head with hands.

5. The mounting system of claim 1, wherein the track attachment device includes an interchangeable attachment assembly that allows the interim assembly to be connected to different track designs.

6. The mounting system of claim 1, wherein the interim assembly contains an electrical transformer.

7. The mounting system of claim 1, wherein the head attachment device comprises at least one magnet and at least one corresponding ferrous plate.

8. The mounting system of claim 1, wherein the head attachment device comprises a first holding device and a second holding device different from the first holding device, each of the first and second holding devices adapted to independently hold the track head to the interim assembly.

9. The mounting system of claim 1, wherein the head attachment device comprises a mechanical latch and a magnetic retainer.

10. The mounting system of claim 9, wherein the mechanical latch is disengaged by insertion of a tool to separate the track head and interim assembly.

11. The mounting system of claim 1, wherein the head attachment device comprises at least one clip and at least one corresponding recess, wherein the at least one clip is cooperative with the at least one recess so as to hold the track head to the interim assembly.

12. The mounting system of claim 1, further comprising a light fixture, wherein at least a portion of the light fixture is attached to the track head.

13. A remotely operable interim assembly designed to mount to a track lighting track using a pre-prescribed mounting method, and receive a separate track head assembly using a different selectively operable mounting method.

14. The remotely operable interim assembly of claim 13, wherein the mounting method for mounting the interim assembly to the track is contained on an interchangeable assembly that could be changed to match different types of track.
